(19) United States
(12) Patent Application Publication
(10) Pub. No.: US 2026/0367567 A1
(43) Pub. Date: Nov. 19, 2026

(54) IMAGE FORMING APPARATUS

(71) Applicant: CANON KABUSHIKI KAISHA, Tokyo (JP)

(72) Inventors: YUKIHIDE ITO, Kanagawa (JP); SHINYA NODA, Shizuoka (JP); YOJI MISAO, Shizuoka (JP); KOJI MIWA, Shizuoka (JP); CHIKARA IMAIZUMI, Shizuoka (JP); HIDEKI OHTA, Shizuoka (JP)

(21) Appl. No.: 19/668,056

(22) Filed: May 5, 2026

(30) Foreign Application Priority Data
May 16, 2025 (JP) 2025-082771

(51) Int. Cl. G03G 21/16; G03G 15/00

(52) U.S. Cl. CPC G03G 21/1647; G03G 15/605; G03G 21/1619; G03G 21/1633; G03G 2221/1639

(57) ABSTRACT

An image forming apparatus includes: a fixing unit configured to be attachable to and detachable from an apparatus main body and to fix the image to the recording material; a support mechanism configured to support the fixing unit so that the fixing unit is movable between a use position and an upper position; and an upper device that is arranged above the fixing unit located at the use position, includes a document table and a reading unit. The fixing unit passes through a removal path when being removed from the apparatus main body from the use position via the upper position. The upper device includes a moving portion being configured to be movable, between a first position overlapping the removal path and a second position separated from the removal path. The moving portion includes the document table.

### BACKGROUND

### Field of the Technology

The present disclosure relates to an image forming apparatus that forms an image on a recording material.

### Description of the Related Art

As an image forming apparatus such as a printer, a copier, and an all-in-one printer, a configuration that includes a fixing unit (fixing apparatus) for fixing a toner image onto a recording material is known.

Japanese Patent Application Laid-open No. 2024-41712 discloses an image forming apparatus including a door that is openable and closable relative to an apparatus main body and a fixing unit capable of moving, in a state in which the door is open, from a use position, where an image forming operation is performed, to a retracted position. The fixing unit is configured to be movable to the retracted position by being held by a rotatable coupling member.

When the fixing unit is moved, any other components overlapping the moving path of the fixing unit will prevent the fixing unit from moving.

### SUMMARY

The present disclosure is directed to represent a further advancement of conventional techniques.

According to some embodiments, an image forming apparatus of the present disclosure is characterized by features including:
an apparatus main body including an image forming portion configured to form an image on a recording material;
a fixing unit configured to be attachable to and detachable from the apparatus main body and configured to fix the image, formed on the recording material, to the recording material;
a support mechanism configured to support the fixing unit so that the fixing unit is movable between a use position for performing a fixing operation and
an upper position above the use position; and an upper device arranged above the fixing unit located at the use position in the apparatus main body, the upper device including a document table and a reading unit configured to read an image from a document placed on the document table,
wherein the fixing unit passes through a removal path when being removed from the apparatus main body from the use position via the upper position, wherein the upper device includes a moving portion, the moving portion being configured to be movable between a first position overlapping the removal path and a second position separated from the removal path,
the moving portion includes the document table.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to a first embodiment.

FIG. 2 is a schematic cross-sectional view of an image scanner according to the first embodiment.

FIG. 3 is a schematic cross-sectional view showing a door open state according to the first embodiment.

FIG. 4 is a schematic perspective view showing a door open state according to the first embodiment.

FIG. 5 is a schematic cross-sectional view showing a fixing apparatus retracting movement state according to the first embodiment.

FIG. 6 is a schematic perspective view showing the fixing apparatus retracting movement state according to the first embodiment.

FIG. 7 is a schematic cross-sectional view showing movement of a transfer unit and a tray unit according to the first embodiment.

FIG. 8 is a schematic cross-sectional view showing a problem relating to the first embodiment.

FIG. 9 is a schematic cross-sectional view showing the positional relationship between a fixing apparatus and an image scanner according to the first embodiment.

FIG. 10 is a schematic cross-sectional view showing the positional relationship between a fixing apparatus and an image scanner according to a second embodiment.

FIG. 11 is a schematic cross-sectional view showing the positional relationship between a fixing apparatus and an image scanner according to a third embodiment.

FIG. 12 is a schematic cross-sectional view showing the positional relationship between a fixing apparatus and an image scanner according to a fourth embodiment.

FIG. 13 is a schematic cross-sectional view showing a problem relating to a fifth embodiment.

FIG. 14 is a schematic cross-sectional view showing the positional relationship between a fixing apparatus and an image scanner according to the fifth embodiment.

### DESCRIPTION OF THE EMBODIMENTS

Hereinafter, embodiments of the present disclosure will be described in detail on the basis of embodiments with reference to the drawings. In this regard, the dimensions, materials, shapes, relative arrangements, and the like of the components described in the embodiments may be appropriately modified according to the configurations and various conditions of apparatuses to which the present disclosure is applied. That is, the scope of the present disclosure is not intended to be limited to the embodiments described below. Furthermore, while a plurality of features are described in the embodiments, all of the plurality of features are not necessarily essential to the disclosure, and the plurality of features may be combined with each other in any way. Moreover, in the accompanying drawings, the same reference numerals are assigned to the same or similar components, and redundant descriptions thereof are omitted.

### First Embodiment

### Overall Configuration

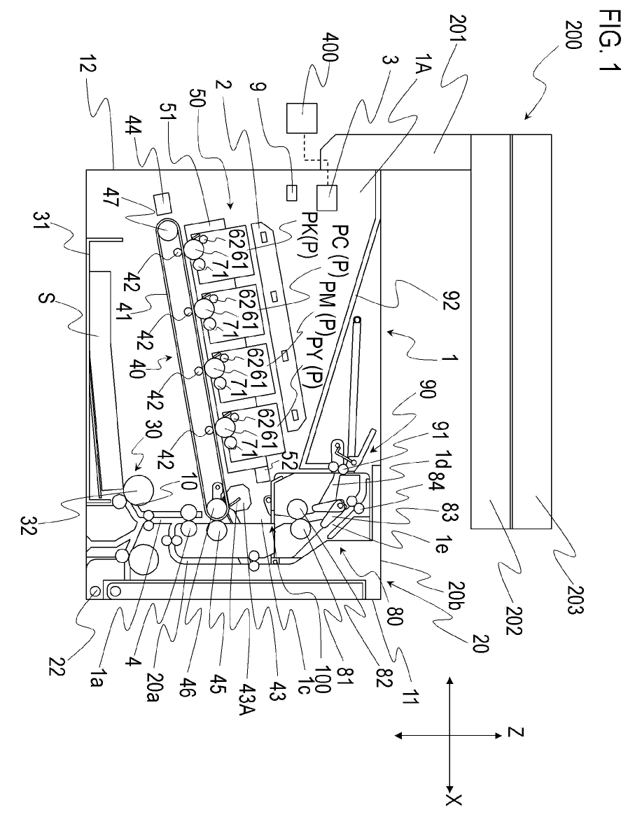

With reference to FIG. 1, a printer 1 used as an image forming apparatus will be described. FIG. 1 is a view illustrating the overall configuration of the printer 1 according to this embodiment. In this embodiment, the printer 1 is an electrophotographic color laser beam printer that forms images on sheets S used as recording materials.

The printer 1 has a housing 1A (apparatus main body), a scanner 2 (exposure device), a control portion 3, and a door 20 (opening and closing member) that can be opened and closed relative to the housing 1A. The printer 1 also includes a sheet feeding portion 30, a transfer unit 40, a tray unit 50 (tray unit, moving unit, support unit), a fixing apparatus 80, a sheet discharge portion 90, and a fixing apparatus moving mechanism 100.

The housing 1A houses the scanner 2, the control portion 3, the sheet feeding portion 30, the transfer unit 40, the tray unit 50, the fixing apparatus 80, the sheet discharge portion 90, and the fixing apparatus moving mechanism 100. The sheet feeding portion 30 has a stacking tray 31 on which sheets S (recording material) are stacked, and a supply roller 32. The stacking tray 31 can be drawn out toward the door 20 (opening and closing member) to replenish sheets S.

The tray unit 50 has a tray (support member, drawer) 51 and toner cartridges PY, PM, PC, and PK. The tray 51 has a tray handle 52. The toner cartridges PY, PM, PC, and PK are attached so that they are removable from the tray 51.

Each of the toner cartridges PY, PM, PC, and PK is independently attachable to and detachable from the tray 51. The toner cartridges PY, PM, PC, and PK accommodate yellow (Y), magenta (M), cyan (C), and black (K) toner (developers), respectively. The toner cartridges PY, PM, PC, and PK share a same configuration with the exception of the colors of toner housed therein. Therefore, the configuration and operations of any one of the toner cartridges PY, PM, PC, and PK will be described, and descriptions of the other toner cartridges will not be repeated. In addition, when it is not necessary to distinguish among the toner cartridges PY, PM, PC, and PK, the toner cartridges PY, PM, PC, and PK may simply be referred to as toner cartridges. The tray unit 50 has a plurality of toner cartridges and the tray 51 to which the toner cartridges are attached so that they are removable.

In this embodiment, the tray unit 50 serving as an image forming portion has a photosensitive drum 61 (image bearing member), a charging roller 62 (charging member), and a developing roller 71 (developer bearing member) for each of the four toner cartridges. The rotation axis directions of the photosensitive drum 61, the developing roller 71, and the charging roller 62 are parallel to each other.

The portion that forms black (K) images is referred to as a black station (first station). The photosensitive drum 61 of the first station is referred to as a first photosensitive drum, the developing roller 71 thereof is referred to as a first developing roller, and the charging roller 62 thereof is referred to as a first charging roller. The portion that forms cyan (C) images is referred to as a cyan station (second station). The photosensitive drum 61 of the second station is referred to as a second photosensitive drum, the developing roller 71 thereof is referred to as a second developing roller, and the charging roller 62 thereof is referred to as a second charging roller. The portion that forms magenta (M) images is referred to as a magenta station (third station). The photosensitive drum 61 of the third station is referred to as a third photosensitive drum, the developing roller 71 thereof is referred to as a third developing roller, and the charging roller 62 thereof is referred to as a third charging roller. The portion that forms yellow (Y) images is referred to as a yellow station (fourth station). The photosensitive drum 61 of the fourth station is referred to as a fourth photosensitive drum, the developing roller 71 thereof is referred to as a fourth developing roller, and the charging roller 62 thereof is referred to as a fourth charging roller. The toner cartridges PK, PC, PM, and PY are attached to the black, cyan, magenta, and yellow stations, respectively. Note that the numbers such as “first,” “second,” “third,” and “fourth” are used merely for convenience of explanation.

While toner cartridges include the photosensitive drum 61, the charging roller 62, and the developing roller 71 in the present embodiment, a configuration in which the tray 51 includes these may also be adopted.

The transfer unit 40 has a belt 41, a primary transfer roller 42, a cleaning portion 43, a driver roller 46 that drives the belt 41, and a tension roller (driven roller) 47. An optical sensor 44 that detects a toner image transferred to the belt 41 is arranged in the printer 1 according to the present embodiment. In this embodiment, the belt 41 is arranged below the photosensitive drums 61, and the primary transfer roller 42 can bring the belt 41 into contact with the photosensitive drum 61 so that a primary transfer portion is formed between the belt 41 and the photosensitive drum 61.

In addition, the printer 1 has a secondary transfer roller 45 that is brought into contact with the belt 41 so that a secondary transfer portion is formed. The secondary transfer portion is formed between the belt 41 and the secondary transfer roller 45. The respective rotation axis directions of the primary transfer roller 42, the driver roller 46, the tension roller 47, and the secondary transfer roller 45 are all parallel to each other. A pair of registration rollers 4 is arranged under the secondary transfer portion.

The fixing apparatus 80 includes a pair of fixing rollers including a heating roller 82, which includes a heater, and a pressure roller 81 for sandwiching and conveying the sheet, and a flapper 83 for switching the conveyance direction of the sheet S to a paper discharge path 1d or a reverse path 1e. When an image forming operation is performed on the sheet S, the fixing apparatus 80 is at the use position as shown in FIG. 1 so as to sandwich and convey the sheet S while heating it.

### Image Scanner

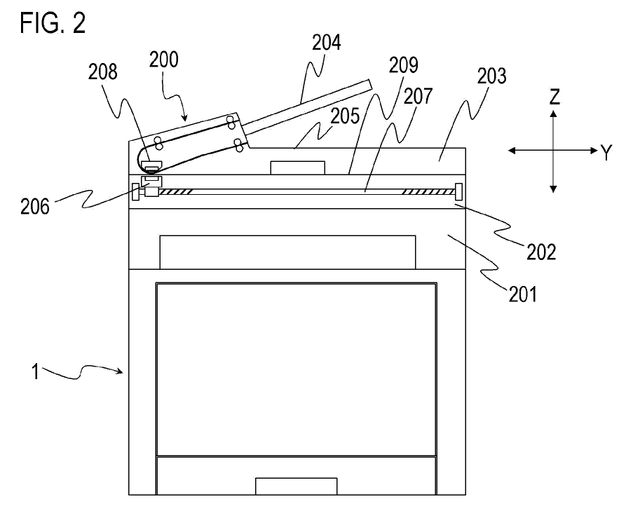

FIG. 2 is a diagram showing the right side of FIG. 1 and is a cross-sectional view for illustrating the overall configuration of an image scanner (document reading apparatus) 200. The image scanner 200 includes an image reading apparatus 202 (reading unit) and a document feeding apparatus 203, and is provided above the printer 1. The image scanner 200 is an example of a document reading apparatus for reading a document, and is also an example of an upper device provided above the printer 1. The image scanner 200 is arranged above a discharge tray 92, which will be described below, and the bottom surface of the image scanner 200 is opposed to the discharge tray 92. The image scanner 200 is attached to an upper part of the printer 1 through a pillar 201 serving as a pillar portion. A document placed on the document tray 204 of the document feeding apparatus 203 is conveyed to image reading portions 206 and 208. The image reading portions 206 and 208 read the respective opposing document surfaces, so that reading of a two-sided document can be completed by one sheet conveyance. The document is discharged to the document discharge portion 205. The image reading apparatus 202 uses a driving apparatus 207 to cause the image reading portion 206 to perform reciprocal scanning, enabling reading of a document such as a booklet document for which the document feeding apparatus 203 cannot be used. The image reading portion 206 is arranged on the inner side of (inside) the document table 209, and the image reading portion 206 is arranged so as to be opposed to the document placement surface of the document table 209. A booklet document or the like is placed on the document placement surface of the document table 209 to be read. The document table 209 is a part of the image reading apparatus 202.

### Fixing Apparatus Moving Operation

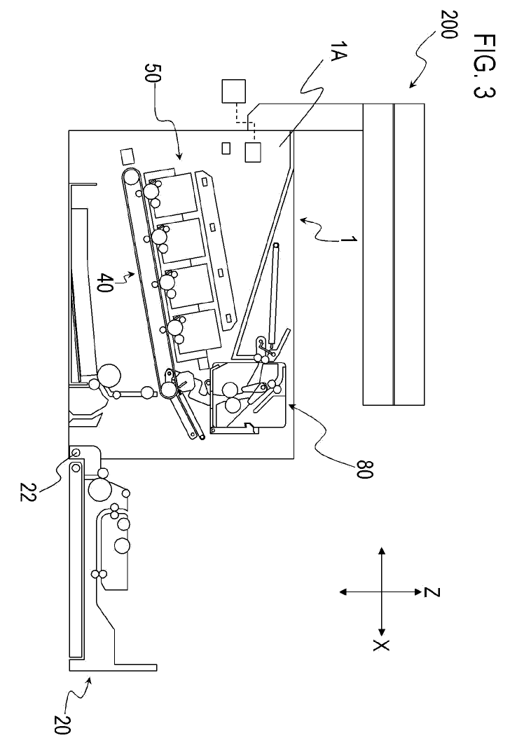

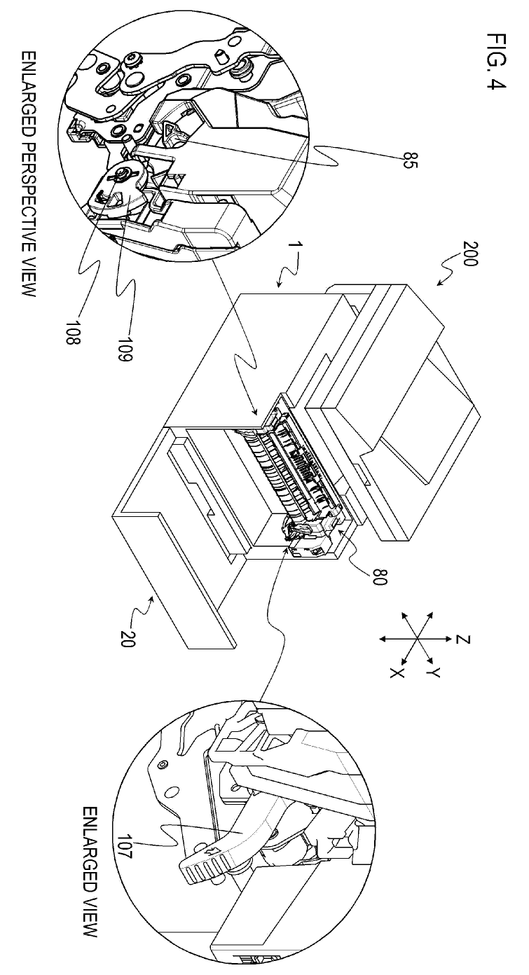

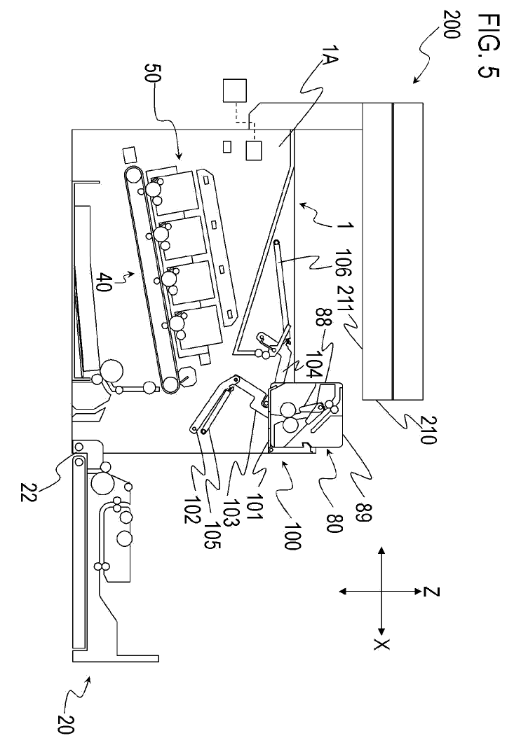

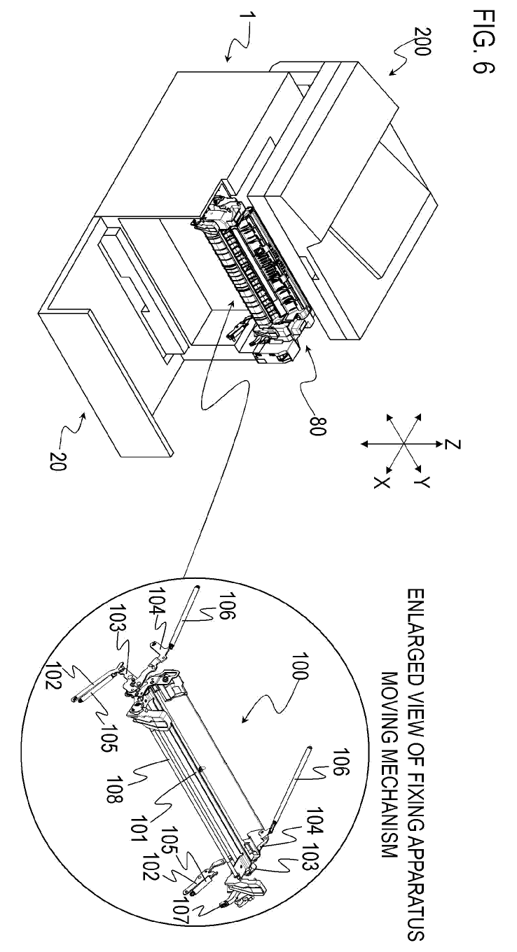

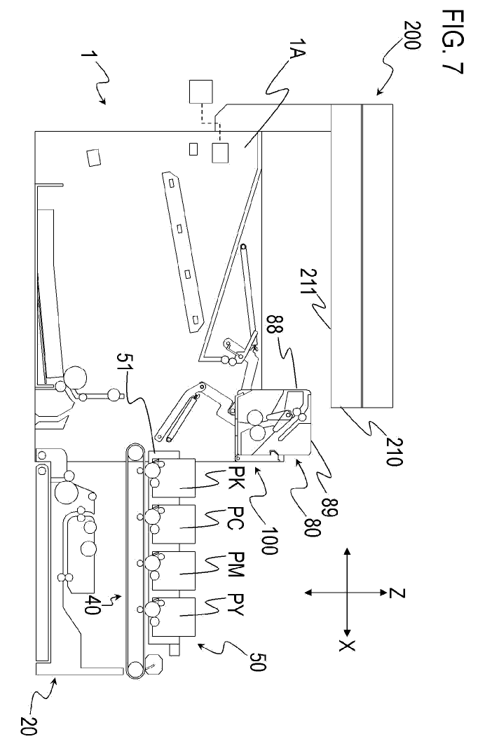

With reference to FIGS. 3 to 7, movement of the transfer unit 40, the tray unit 50, the fixing apparatus 80, and the fixing apparatus moving mechanism 100 is now described. FIG. 3 is a cross-sectional view of the printer 1 in a state in which the door 20 is opened. FIG. 4 is a perspective view of the printer 1 in a state in which the door 20 is opened. FIG. 5 is a cross-sectional view of the printer 1 in a state in which the fixing apparatus 80 has undergone retracting movement. FIG. 6 is a perspective view of the printer 1 in a state in which the fixing apparatus 80 has undergone retracting movement. FIG. 7 is a cross-sectional view of the printer 1 in a state in which the transfer unit 40 and the tray unit 50 have moved to external positions.

As shown in FIG. 3, the door 20 attached to the housing 1A is rotatable about a door hinge 22 between a closing position and an opening position.

As shown in FIG. 5, the fixing apparatus 80 serving as a fixing unit is supported by a support member 101 receiving the bottom surface of the fixing apparatus 80 in the fixing apparatus moving mechanism 100, which serves as a support mechanism. The position of the fixing apparatus 80 shown in FIG. 5 is an upper position which is above the use position (FIG. 3) for the fixing operation. As shown in FIG. 6, three arm members (a lower arm 102, a center arm 103, and an upper arm 104) connected movably with each other are provided on both sides in the longitudinal direction of the support member 101. Of these, the center arm 103 is connected to the support member 101. On both sides in the longitudinal direction, the lower arm 102 is provided with a lower lift spring 105, and the upper arm 104 is provided with an upper lift spring 106. One end of the lower lift spring 105 is engaged with the lower arm 102, and the other end is engaged with the housing 1A. Similarly, one end of the upper lift spring 106 is engaged with the upper arm 104, and the other end thereof is engaged with the housing 1A. This configuration urges the support member 101 in a direction from an inside position to an outside position of the housing 1A.

As shown in FIG. 4, the fixing apparatus 80 includes a lock member 85, which engages a shaft (not shown) provided on the housing 1A to restrict the movement of the fixing apparatus 80 and the support member 101. Although only the lock member configuration on one side of the apparatus has been described here, a similar lock member structure is also arranged on the opposite side.

As shown in FIGS. 4 and 6, the fixing apparatus moving mechanism 100 includes a release lever 107 for releasing the locked state of the lock member 85. The release lever 107 is connected to a link shaft 108, and a link member 109 is attached to the link shaft 108. When the release lever 107 is rotated, the link member 109 is rotated through the link shaft 108. Rotation of the link member 109 causes the lock member 85 to move, thereby releasing the engagement with the housing 1A. Only the lock releasing configuration on one side of the apparatus has been described, but a similar lock releasing configuration is also arranged on the opposite side.

By operating the release lever 107, the lock member 85 is released from its locked state, and the fixing apparatus 80 and the fixing apparatus moving mechanism 100 integrally perform upward retracting movement (move from the state shown in FIGS. 3 and 4 to the state shown in FIGS. 5 and 6). The fixing apparatus 80 and the fixing apparatus moving mechanism 100 are moved by the urging forces of lift springs 105 and 106 provided in the fixing apparatus moving mechanism 100, without the application of any force by the user.

As shown in FIG. 5, a fixing apparatus rear edge surface 88 and a fixing apparatus upper edge surface 89 of the fixing apparatus 80 after retracting movement are located apart from an image scanner front edge surface 210 and an image scanner lower edge surface 211 of the image scanner.

Then, as shown in FIG. 7, the transfer unit 40 and the tray unit 50 can move from an inside position inside the housing 1A to an outside position outside the housing 1A through an opening portion formed by the retracting movement of the fixing apparatus 80 and the fixing apparatus moving mechanism 100. The fixing apparatus 80 located at the use position overlaps a moving path of the tray unit 50 moving from the inside to the outside of the housing 1A. Also, it can be understood that the fixing apparatus 80 moves away from the moving path of the tray unit 50 by moving from the use position to an upper position. In this embodiment, when the tray unit 50 moves from the inside position inside the housing 1A to the outside position outside the housing 1A, the transfer unit 40 moves together with the tray unit 50 from the inside position inside the housing 1A to the outside position outside the housing 1A. That is, it can be understood that the fixing apparatus 80 located at the use position overlaps a moving path of the transfer unit 40 and the tray unit 50 moving from the inside to the outside of the housing 1A. Also, it can be understood that the fixing apparatus 80 moves away from the moving path of the transfer unit 40 and the tray unit 50 by moving from the use position to the upper position. The moving direction of the transfer unit 40 and the tray unit 50 is a direction intersecting with the rotation axis direction of the photosensitive drum 61.

In a state in which the fixing apparatus 80 is located at the upper position (retracted position), the fixing apparatus 80 can be removed from the fixing apparatus moving mechanism 100 by moving the fixing apparatus 80 by a predetermined distance relative to the fixing apparatus moving mechanism 100.

In a state in which the transfer unit 40 and the tray unit 50 have been moved to the outside of the housing 1A as shown in FIG. 7, the toner cartridges PY to PK can be removed from the tray 51 and the toner cartridges PY to PK can be mounted to the tray 51. Accordingly, the toner cartridges PY to PK can be replaced with new toner cartridges PY to PK. Also, the transfer unit 40 is drawable out from and removable from the housing 1A independently of the tray 51 and is replaceable with a new transfer unit 40.

### Image Forming Operation

An image forming operation of the printer 1 will be described with reference to FIG. 1. The control portion 3 of the printer 1 starts the image forming operation on a sheet S on the basis of an image signal received from an external host apparatus 400. The external host apparatus 400 is, for example, a personal computer, an image reader, a facsimile machine, or the like.

When an image is formed on the sheet S, the fixing apparatus 80 is in the use position, the tray unit 50 and the transfer unit 40 are in the inside position, and the door 20 is in the closing position. When the transfer unit 40 is in the inside position, the belt 41 can come into contact with the photosensitive drums 61.

A charging voltage is applied to the charging roller 62, and the photosensitive drum 61 is rotated. A laser corresponding to image information is emitted from the scanner 2 to the photosensitive drum 61 and is exposed on a surface of the photosensitive drum 61 that has been charged by the charging roller 62. Accordingly, an electrostatic latent image corresponding to the image information is formed on the surface of the photosensitive drum 61.

A developing voltage is applied to the developing roller 71 bearing toner, and the electrostatic latent image formed on the photosensitive drum 61 is developed by the toner supplied from the developing roller 71, so that a toner image is formed on the surface of the photosensitive drum 61. While the developing roller 71 develops electrostatic latent images in a state in which the developing roller 71 is in contact with the photosensitive drum 61 in the present embodiment, a configuration may also be adopted in which the developing roller 71 develops electrostatic latent images in a state in which a gap is present between the developing roller 71 and the photosensitive drum 61.

When a full-color image is formed, a toner image of each color is formed on each photosensitive drum 61. Note that when the tray unit 50 is in the inside position, the developing rollers 71 are movable between a contact position where they are in contact with the photosensitive drums 61 and a separated position where they are separated from the photosensitive drums 61. Specifically, the housing 1A includes a switching apparatus (not shown), which switches between a state in which the developing roller 71 is at the contact position and a state in which the developing roller 71 is at the separated position. This allows the developing roller 71 to be separated from the photosensitive drum 61 while an image forming operation is not performed. Furthermore, the printer 1 is capable of performing mono-color printing in a state in which the developing roller 71 and the photosensitive drum 61 corresponding to the toner cartridge PK are in contact with each other, while the developing rollers 71 and the photosensitive drums 61 corresponding to the respective toner cartridges PY, PM, and PC are separated from each other.

The toner image formed on each photosensitive drum 61 is transferred onto the belt 41 by the primary transfer roller 42 in the primary transfer portion, and moved toward the secondary transfer portion formed by the belt 41 and the secondary transfer roller 45. On the other hand, a conveyance path 1c through which the sheet S moving toward the fixing apparatus 80 passes is formed in the housing 1A. On the inner side of the door 20, a double-sided conveyance path 20a through which the sheet S passes after passing through the fixing apparatus 80 is formed. When the door 20 is opened (moved to the opening position), the conveyance path 1c and a part of the double-sided conveyance path 20a are exposed.

In the sheet feeding portion 30, one sheet S is separated and fed from the sheets S stacked on the stacking tray 31 by the supply roller 32 at a predetermined timing, and is conveyed toward the secondary transfer portion through a sheet feeding and conveying path 1a. In the secondary transfer portion, the toner image is transferred from the belt 41 to the sheet S. The toner that is not transferred to the sheet S is removed from the belt 41 by a cleaning blade (cleaning member) 43A provided in the cleaning portion 43.

The sheet S, onto which the toner images have been transferred in the secondary transfer portion, is transported toward the fixing apparatus 80. In the fixing apparatus 80, the sheet S is heated, sandwiched, and pressed by the fixing roller pair, and the toner image is fixed to the sheet S. The sheet S to which the toner image has been fixed is conveyed toward the flapper 83 as a conveyance path switching portion.

The flapper 83 is movable to a paper discharge position (solid line in FIG. 1) where the sheet S having passed through the fixing apparatus 80 is guided toward the paper discharge path 1d and to a reverse position (dashed line in FIG. 1) where the sheet S is guided toward the reverse path 1e. When printing is only performed on one side, the sheet S is guided to the paper discharge path 1d by the flapper 83 and discharged by a discharge roller 91 to a discharge tray 92 formed in an upper portion of the housing 1A. When double-sided printing is performed, the sheet S is guided to the reverse path 1e by the flapper 83. After the sheet S is guided to the reverse path 1e, the conveying direction of the sheet S is reversed by a reversing roller 84, and the sheet S passes through the double-sided conveyance path 20a formed inside the door 20 and is conveyed once again toward the secondary transfer portion. Subsequently, after a toner image is transferred to the rear surface in the secondary transfer portion, the sheet S once again passes through the fixing apparatus 80, guided to the paper discharge path 1d by the flapper 83, and discharged by the discharge roller 91 to the discharge tray 92.

X and Y in the drawings are parallel to the horizontal direction and perpendicular to each other. Z indicates the vertical direction. Furthermore, one side in the X direction is a front side of the image forming apparatus according to this embodiment, and the other side is a rear side. The Y direction is the width direction of the image forming apparatus. The Y direction is parallel to the direction of the rotation axis of the photosensitive drum 61. The moving direction of the tray unit 50, the moving direction of the transfer unit 40, and the moving direction of the fixing apparatus 80 are directions intersecting the Y direction (preferably a direction orthogonal thereto). The drawings show a state in which the image forming apparatus is installed on a horizontal plane as an ordinarily assumed installation state. In the present embodiment, the door 20 is provided at a first end 11, which is one end of the housing 1A in the horizontal direction (X direction). The pillar 201 serving as a pillar portion supporting the image scanner 200 is closer to a second end 12, which is the other end opposite to the first end 11, than to the first end 11 of the housing 1A in the horizontal direction (X direction). In the present embodiment, the pillar 201 is connected to the second end 12.

### Full Front Access

For the printer 1 having the above-described configuration, various maintenance operations that are performed while no images are formed can be performed from the side on which the door 20 is attached (the right side in FIG. 1) while the door 20 is opened. Examples of the operations performed while the door 20 is opened include attaching and detaching the fixing apparatus 80, attaching and detaching the tray unit 50, exchanging toner cartridges, and removing the sheet S when a paper jam occurs in the housing 1A. This mode is referred to as full front access, and since all the operations for maintenance and consumable replacement are performed at the front of the printer, it is possible to improve usability and minimize the space required for maintenance.

### Problems

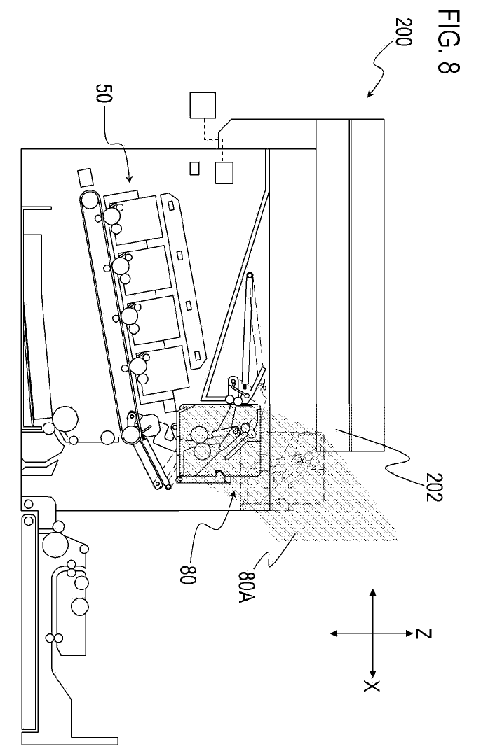

With reference to FIG. 8, problems to be solved in the present embodiment are now described. From the standpoint of merchandise competitiveness of the image forming apparatus, downsizing is an important point. In the present embodiment, since the fixing apparatus 80 is lifted up to be retracted from a trajectory of attachment and detachment of the tray unit 50, the fixing apparatus 80 and the tray unit 50 can be placed closer to each other during image formation. As a result, in the present embodiment, the volume of the housing 1A can be reduced, and downsizing of the housing 1A and full front access can be achieved at the same time.

As for a product having the image scanner 200, the entire image forming apparatus including the image scanner 200 can be downsized by lowering the installation height of the image scanner 200. However, as the product is further downsized, there is a possibility that the image scanner 200 may interfere with the fixing apparatus 80 being lifted up. Specifically, the entire apparatus can be downsized by placing the image scanner 200 in close proximity to the fixing apparatus 80 to the extent that it overlaps the movement trajectory of the fixing apparatus 80 during lift-up or during attachment and detachment before and after lift-up. However, if the image scanner 200 is fixed at that position, lift-up and attaching/detaching of the fixing apparatus 80 would be hindered.

FIG. 8 shows a fixing apparatus moving space 80A (hatched area in FIG. 8), which is the trajectory of attachment and detachment of the fixing apparatus 80. The fixing apparatus moving space 80A is a region through which the fixing apparatus 80 passes in the process of a lift-up operation of the fixing apparatus 80 from an inside position of the housing 1A to an outside position (indicated by dotted lines) and a removal operation of the fixing apparatus 80 from the fixing apparatus moving mechanism 100. Here, the inside position of the fixing apparatus 80 is the above-mentioned use position of the fixing apparatus 80. The position at which the fixing apparatus 80 is separated from the fixing apparatus moving mechanism 100 is a removal position of the fixing apparatus 80. That is, the fixing apparatus moving space 80A is a removal path (attachment and detachment path) for the fixing apparatus 80 to follow from the use position (FIG. 3), via the upper position (FIG. 5), until it is removed from the fixing apparatus moving mechanism 100 by a lift-up operation. That is, the fixing apparatus moving space 80A is a trajectory of movement of the fixing apparatus 80 from an inside position to a removal position. In other words, while moving from the inside position to the removal position, the fixing apparatus 80 is in contact with the fixing apparatus moving mechanism 100, which is a part of the housing 1A. As shown in the drawing, since a part of the image reading apparatus 202 is located inside the fixing apparatus moving space 80A (at a position overlapping the fixing apparatus moving space 80A (first position)), there is a possibility of interference. In other words, when the printer 1 having the full front access configuration and including the image scanner 200 is downsized, there is a problem that the fixing apparatus 80 cannot be attached or detached due to interference with the image scanner 200.

### Details and Effects of Disclosure

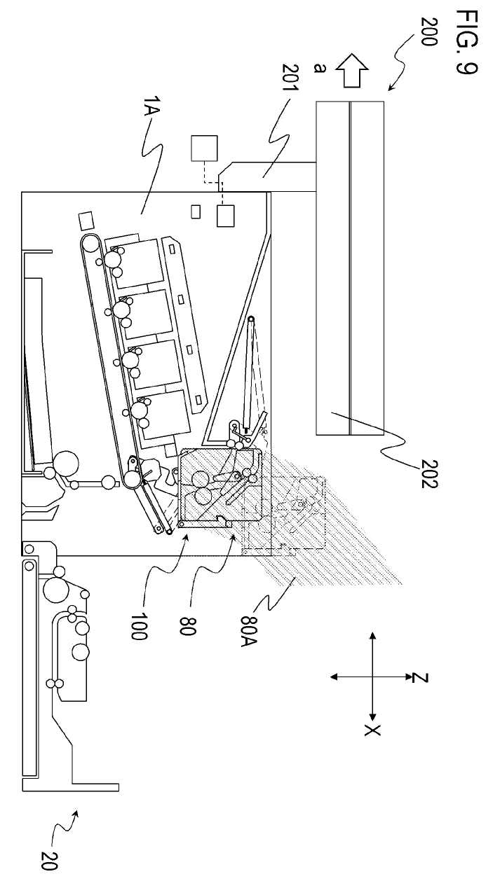

FIG. 9 is a schematic cross-sectional view illustrating the overall configuration of the printer 1 including the image scanner 200 according to the present embodiment for solving the above problem. The image scanner 200 serving as a moving portion is configured to be slidable relative to the housing 1A and the pillar 201 in a direction away from the fixing apparatus 80 (image scanner moving direction a). This allows the image scanner 200 to be positioned outside the fixing apparatus moving space 80A (at a position separated from the fixing apparatus moving space 80A (second position)) when attaching or detaching the fixing apparatus 80. As a result, the fixing apparatus 80 can be attached and detached without interference, thereby achieving both overall downsizing and full front access of the printer 1 including the image scanner 200.

In the X direction (horizontal direction), the fixing apparatus 80 located at the use position is located at a position closer to the first end 11 than to the second end 12 of the housing 1A. The movement of the image scanner 200 from a first position that overlaps the fixing apparatus moving space 80A to a second position that is separated from the fixing apparatus moving space 80A is movement of the image scanner 200 (document table 209) in a direction from the first end 11 toward the second end 12 of the housing 1A. The first position at which the image scanner 200 overlaps the fixing apparatus moving space 80A is a position at which the image reading apparatus 202 in the image scanner 200 performs a document reading operation. In other words, while the image scanner 200 is located at the first position, the image reading apparatus 202 is permitted to perform a document reading operation. Alternatively, the image scanner 200 may be permitted to perform a document reading operation while it is at the second position.

The above movement of the image scanner 200 is not limited to a specific configuration, and may be configured to be movable independently of, for example, the opening operation of the door 20 or the lift-up operation of the fixing apparatus moving mechanism 100. In this embodiment, as a mechanism to cause the image scanner 200 to slide in the horizontal direction, for example, a configuration may be adopted in which one of the pillar 201 and the image reading apparatus 202 includes a guided portion (e.g., a protrusion), and the other includes a guide portion (e.g., a groove into which the protrusion is inserted). Alternatively, a rotatable roller may be placed on one of the pillar 201 and the image reading apparatus 202, and the other may run on the roller. A user standing on the front side of the apparatus can slide the image scanner 200 in the horizontal direction relative to the housing 1A manually, that is, by pushing or pulling the image scanner 200. As a result, the entire image scanner 200 including the image reading apparatus 202 having the document table 209 is displaced relative to the housing 1A.

Also, usability can be improved by adopting a configuration in which movement of the image scanner 200 is interlocked with the opening operation of the door 20 or the lift-up operation of the fixing apparatus moving mechanism 100. As the interlocking mechanism, a mechanical interlocking structure composed of a link, a gear train (including a rack and a pinion) or the like may be employed.

As described above, in the present embodiment, when the image scanner 200 is located at the first position, removal of the fixing apparatus 80 from the housing 1A is restricted. More specifically, the image scanner 200 located at the first position overlaps the fixing apparatus moving space 80A. In this embodiment, the image scanner 200 located at the first position overlaps a space through which the fixing apparatus 80 moves from the use position to the removal position. In other words, the image scanner 200 located at the first position restricts movement of the fixing apparatus 80 from the use position to the removal position. However, when the image scanner 200 moves to the second position, the fixing apparatus 80 is permitted to move from the use position to the removal position. Furthermore, in this embodiment, the image scanner 200 located at the first position overlaps a space through which the fixing apparatus 80 moves from the use position to the upper position. In other words, the image scanner 200 located at the first position restricts movement of the fixing apparatus 80 from the use position to the upper position. However, when the image scanner 200 moves to the second position, the fixing apparatus 80 is permitted to move from the use position to the upper position.

### Second Embodiment

### Details and Effects of Disclosure

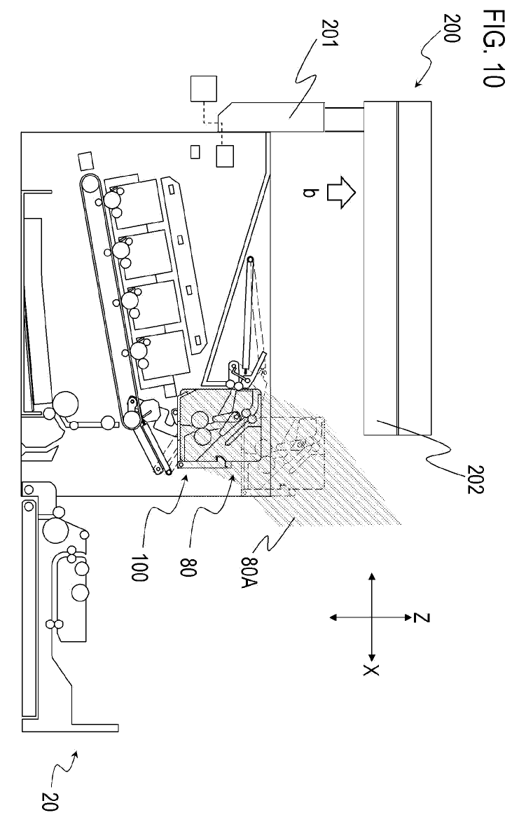

FIG. 10 is a schematic cross-sectional view illustrating the overall configuration of a printer 1 having an image scanner 200 according to a second embodiment of the present disclosure for solving the above problem. Here, points different from the first embodiment in the second embodiment will be described, and description of points common to the first embodiment in the second embodiment will be omitted.

In the present embodiment, the pillar 201, which is a pillar portion for supporting the image scanner 200, is extendable upward. When the pillar 201 extends upward, the image scanner 200 can move upward (image scanner moving direction b). That is, the movement of the image scanner 200 from a first position that overlaps the fixing apparatus moving space 80A to a second position that is separated from the fixing apparatus moving space 80A is movement of the image scanner 200 (document table 209) from a lower side to an upper side relative to the housing 1A. Thus, when attaching or detaching the fixing apparatus 80, the image reading apparatus 202 (document table 209) can be positioned outside the fixing apparatus moving space 80A. As a result, the fixing apparatus 80 can be attached and detached without interference, thereby achieving both overall downsizing and full front access of the printer 1 including the image scanner 200.

The above movement of the image scanner 200 is not limited to a specific configuration, and may be configured to be movable independently of, for example, the opening operation of the door 20 or the lift-up operation of the fixing apparatus moving mechanism 100. In this embodiment, as a mechanism to cause the image scanner 200 to slide in the vertical direction, a configuration may be adopted in which, as in the first embodiment, one of the pillar 201 and the image reading apparatus 202 includes a guided portion (e.g., a protrusion), and the other includes a guide portion (e.g., a groove into which the protrusion is inserted), for example. A user standing on the front side of the apparatus can slide the image scanner 200 vertically relative to the housing 1A manually, that is, by lifting or pushing down the image scanner 200.

Alternatively, an urging member, such as a spring for applying an urging force upward in the vertical direction, may be provided inside the pillar 201, so that the image scanner 200 is urged upward in the vertical direction to slide in the vertical direction. The upward movement of the image scanner 200 is usually restricted by a stopper. When vertical movement is required, the stopper is released so that the image scanner 200 moves upward due to the aforementioned urging force. To return the image scanner 200 to the use position, the image scanner 200 is pushed down against the urging force to return the image scanner 200 to the restricted state by the stopper.

Also, usability can be improved by adopting a configuration in which movement of the image scanner 200 is interlocked with the opening operation of the door 20 or the lift-up operation of the fixing apparatus moving mechanism 100. As the interlocking mechanism, a mechanical interlocking structure composed of a link, a gear train (including a rack and a pinion) or the like may be employed.

As described above, in the present embodiment, when the image scanner 200 is located at the first position, removal of the fixing apparatus 80 from the housing 1A is restricted. More specifically, the image scanner 200 located at the first position overlaps the fixing apparatus moving space 80A. In this embodiment, the image scanner 200 located at the first position overlaps a space through which the fixing apparatus 80 moves from the use position to the removal position. In other words, the image scanner 200 located at the first position restricts movement of the fixing apparatus 80 from the use position to the removal position. However, when the image scanner 200 moves to the second position, the fixing apparatus 80 is permitted to move from the use position to the removal position. Furthermore, in this embodiment, the image scanner 200 located at the first position overlaps a space through which the fixing apparatus 80 moves from the use position to the upper position. In other words, the image scanner 200 located at the first position restricts movement of the fixing apparatus 80 from the use position to the upper position. However, when the image scanner 200 moves to the second position, the fixing apparatus 80 is permitted to move from the use position to the upper position.

### Third Embodiment

### Details and Effects of Disclosure

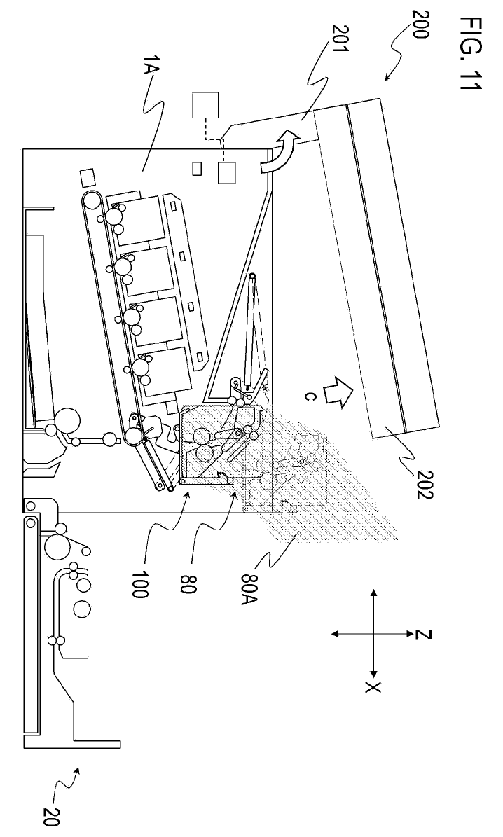

FIG. 11 is a schematic cross-sectional view illustrating the overall configuration of a printer 1 having an image scanner 200 according to a third embodiment of the present disclosure for solving the above problem. Here, points different from the first and second embodiments in the third embodiment will be described, and description of points common to the first and second embodiments in the third embodiment will be omitted.

In the present embodiment, the image scanner 200 serving as a moving portion is configured to be rotatable relative to the housing 1A together with the pillar 201 supporting the image scanner 200. For example, one of the housing 1A and the pillar 201 may include a shaft extending in the Y direction which intersects the vertical direction, the other may include a hole into which the shaft is inserted, and rotation of the shaft in the hole may allow the image scanner 200 and the pillar 201 to integrally rotate relative to the housing 1A. For example, a user standing on the front side of the apparatus can rotate the image scanner 200 relative to the housing 1A manually, that is, by lifting or depressing the front surface end of the image scanner 200. Thus, the image reading apparatus 202 (document table 209) can be rotated relative to the housing 1A about the rotation axis extending in the direction (Y direction) intersecting the vertical direction.

As a result, when attaching or detaching the fixing apparatus 80, the image reading apparatus 202 (document table 209) can be positioned outside the fixing apparatus moving space 80A (image scanner moving direction c). At this time, the end portion of the image reading apparatus 202 (document table 209) on the side corresponding to the first end 11 of the housing 1A moves relative to the end portion of the image reading apparatus 202 on the side corresponding to the second end 12 of the housing 1A from a lower side to an upper side and in a direction from the first end 11 toward the second end 12 of the housing 1A. Thus, the fixing apparatus 80 can be attached and detached without interference, thereby achieving both overall downsizing and full front access of the printer 1 including the image scanner 200.

The above movement of the image scanner 200 may be performed independently of the opening operation of the door 20 or the lift-up operation of the fixing apparatus moving mechanism 100, but it is not limited thereto. Usability can be improved by adopting a configuration in which movement of the image scanner 200 is interlocked with the opening operation of the door 20 or the lift-up operation of the fixing apparatus moving mechanism 100.

As described above, in the present embodiment, when the image scanner 200 is located at the first position, removal of the fixing apparatus 80 from the housing 1A is restricted. More specifically, the image scanner 200 located at the first position overlaps the fixing apparatus moving space 80A. In this embodiment, the image scanner 200 located at the first position overlaps a space through which the fixing apparatus 80 moves from the use position to the removal position. In other words, the image scanner 200 located at the first position restricts movement of the fixing apparatus 80 from the use position to the removal position. However, when the image scanner 200 moves to the second position, the fixing apparatus 80 is permitted to move from the use position to the removal position. Furthermore, in this embodiment, the image scanner 200 located at the first position overlaps a space through which the fixing apparatus 80 moves from the use position to the upper position. In other words, the image scanner 200 located at the first position restricts movement of the fixing apparatus 80 from the use position to the upper position. However, when the image scanner 200 moves to the second position, the fixing apparatus 80 is permitted to move from the use position to the upper position.

### Fourth Embodiment

### Details and Effects of Disclosure

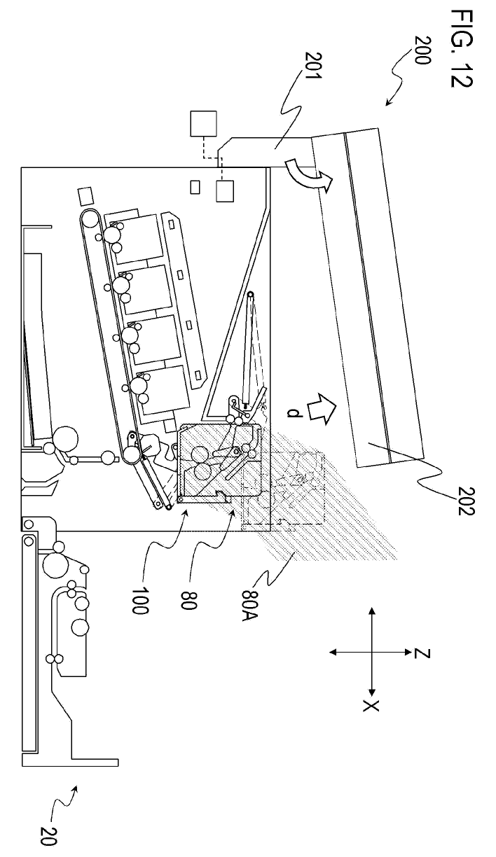

FIG. 12 is a schematic cross-sectional view illustrating the overall configuration of a printer 1 having an image scanner 200 according to a fourth embodiment of the present disclosure for solving the above problem. Here, points different from the first, second, and third embodiments in the fourth embodiment will be described, and description of points common to the first, second, and third embodiments in the fourth embodiment will be omitted.

In this embodiment, the image scanner 200 is configured to be rotatable relative to the pillar 201. For example, one of the image scanner 200 and the pillar 201 may include a shaft extending in a direction intersecting the vertical direction (Y direction), the other may include a hole into which the shaft is inserted, and rotation of the shaft in the hole may allow the image scanner 200 to rotate relative to the pillar 201. For example, a user standing on the front side of the apparatus can rotate the image scanner 200 relative to the housing 1A manually, that is, by lifting or depressing the front surface end of the image scanner 200. Thus, the image reading apparatus 202 (document table 209) can be rotated relative to the housing 1A about the rotation axis extending in the direction (Y direction) intersecting the vertical direction.

As a result, when attaching or detaching the fixing apparatus 80, the image reading apparatus 202 can be positioned outside the fixing apparatus moving space 80A (image scanner moving direction d). At this time, the end portion of the image reading apparatus 202 (document table 209) on the side corresponding to the first end 11 of the housing 1A moves relative to the end portion of the image reading apparatus 202 on the side corresponding to the second end 12 of the housing 1A from a lower position to an upper position and in a direction from the first end 11 toward the second end 12 of the housing 1A. Thus, the fixing apparatus 80 can be attached and detached without interference, thereby achieving both overall downsizing and full front access of the printer 1 including the image scanner 200.

Although the image scanner 200 may be moved independently of the opening operation of the door 20, the movement of the image scanner 200 is not limited to this. Usability can be improved by adopting a configuration in which movement of the image scanner 200 is interlocked with the opening operation of the door 20, or the lift-up operation of the fixing apparatus moving mechanism 100.

It should be noted that the movement of the image scanner 200 described in the first to fourth embodiments is not limited to an independent configuration, and the amount of movement of the image scanner 200 can be minimized by combining the respective movement configurations and moving directions.

As described above, in the present embodiment, when the image scanner 200 is located at the first position, removal of the fixing apparatus 80 from the housing 1A is restricted. More specifically, the image scanner 200 located at the first position overlaps the fixing apparatus moving space 80A. In this embodiment, the image scanner 200 located at the first position overlaps a space through which the fixing apparatus 80 moves from the use position to the removal position. In other words, the image scanner 200 located at the first position restricts movement of the fixing apparatus 80 from the use position to the removal position. However, when the image scanner 200 moves to the second position, the fixing apparatus 80 is permitted to move from the use position to the removal position. Furthermore, in this embodiment, the image scanner 200 located at the first position overlaps a space through which the fixing apparatus 80 moves from the use position to the upper position. In other words, the image scanner 200 located at the first position restricts movement of the fixing apparatus 80 from the use position to the upper position. However, when the image scanner 200 moves to the second position, the fixing apparatus 80 is permitted to move from the use position to the upper position.

### Fifth Embodiment

### Configuration and Problems Related to Operation Unit

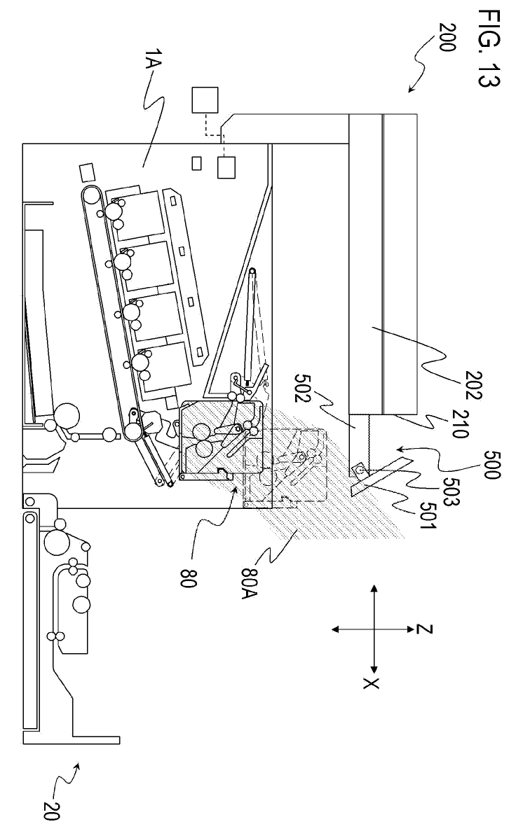

Referring to FIG. 13, the configuration and problems related to an operation unit 500 are now described. In the printer 1 having the image scanner 200, the image scanner 200 may include an operation unit 500, which serves as an interface to be operated by a user. The operation unit 500 may be provided at one end of the image scanner 200. In view of full front access, the operation unit 500 is also provided on the side corresponding to the door 20 of the housing 1A. The operation unit 500 is a portion that receives operations related to operations of the image reading apparatus 202.

The operation unit 500 includes an operation panel 501, which serves as an operation portion actually operated by a user, a support portion 502, which serves as a support member supporting the operation panel 501, and a rotation portion 503, which is provided on the operation panel 501 and the support portion 502 to improve the visibility of the operation panel 501. The support portion 502 is slidable in the horizontal direction relative to the image scanner 200, so that the position for supporting the operation panel 501 can be displaced in the horizontal direction.

In this case, an image scanner front edge surface 210 of the image scanner 200 is separated from the fixing apparatus 80 by the volume of the operation unit 500, reducing the possibility that a part of the image reading apparatus 202 is positioned inside the fixing apparatus moving space 80A as in the first embodiment. However, the possibility that a part of the operation panel 501 or a part of the support portion 502 is positioned inside the fixing apparatus moving space 80A is increased. That is, with the printer 1 having a full front access configuration for downsizing the housing 1A and including the image scanner 200, interference with the operation unit 500 may prevent the fixing apparatus 80 from being attached or detached.

### Details and Effects of Disclosure

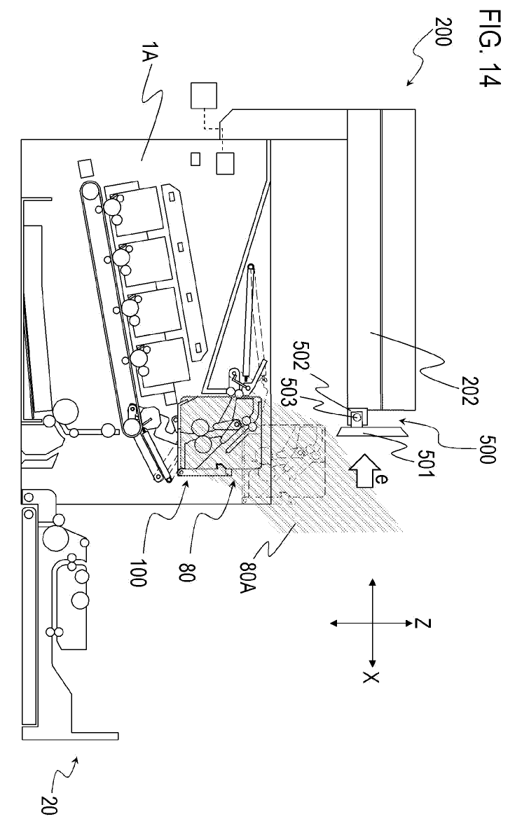

FIG. 14 is a schematic cross-sectional view illustrating the overall configuration of the printer 1 including the image scanner 200 according to the present embodiment for solving the above problem. The operation unit 500 serving as a moving portion is configured to be linearly movable in a direction toward the image reading apparatus 202 (operation unit moving direction e). Thus, in combination with rotation by the rotation portion 503, the entire operation unit 500 can be moved to the outside of the fixing apparatus moving space 80A.

The movement of the operation unit 500 from a first position that overlaps the fixing apparatus moving space 80A to a second position that is separated from the fixing apparatus moving space 80A is movement of the operation unit 500 (operation panel 501) from the first end 11 toward the second end 12 of the housing 1A. Alternatively, the movement is such that the position at which the support portion 502 supports the operation panel 501 is displaced in a direction from the first end 11 toward the second end 12 of the housing 1A. The moving path of the operation unit 500 relative to the image scanner 200 (housing 1A) is a linear path along the horizontal direction.

Also, the operation panel 501 is supported at the rotation portion 503 so as to be rotatable relative to the support portion 502 about a rotation axis in a direction (Y direction) intersecting the up-down direction. The operation panel 501 is configured to be capable of assuming a tilted orientation (FIG. 13) in which its lower end protrudes further toward the first end 11 of the housing 1A than its upper end and an upright orientation (FIG. 14) in which the positions of the lower and upper ends are substantially aligned in the horizontal direction (X direction). It is configured such that when the position at which the support portion 502 supports the operation panel 501 is displaced from the side corresponding to the first end 11 of the housing 1A to the side corresponding to the second end 12, the orientation of the operation panel 501 changes from the tilted orientation (FIG. 13) to the upright orientation (FIG. 14) described above.

According to this embodiment, interference between the operation unit 500 and the fixing apparatus 80 can be avoided, and the image scanner 200 can include the operation unit 500 while achieving both the downsizing of the housing 1A and full front access.

Although the above-described operation unit 500 may be configured to be movable independently of the opening operation of the door 20, usability can be improved by adopting a configuration in which movement of the operation unit 500 is interlocked with the opening operation of the door 20, or the lift-up operation of the fixing apparatus moving mechanism 100.

The sliding movement of the operation unit 500 (support portion 502) relative to the image scanner 200 and the rotation of the operation panel 501 relative to the support portion 502 may be achieved by suitably adopting various mechanisms described in the first to fourth embodiments. Also, these operations may be achieved independently of the opening operation of the door 20 or the lift-up operation of the fixing apparatus moving mechanism 100, or may be achieved in an interlocked manner.

As described above, in this embodiment, when the operation unit 500 (operation panel 501) is located at the first position, removal of the fixing apparatus 80 from the housing 1A is restricted. More specifically, the operation unit 500 (operation panel 501) located at the first position overlaps the fixing apparatus moving space 80A. In this embodiment, the operation unit 500 (operation panel 501) located at the first position overlaps a space through which the fixing apparatus 80 moves from the use position to the removal position. In other words, the operation unit 500 (operation panel 501) located at the first position restricts movement of the fixing apparatus 80 from the use position to the removal position. However, when the operation unit 500 (operation panel 501) moves to the second position, the fixing apparatus 80 is permitted to move from the use position to the removal position. Furthermore, in this embodiment, the operation unit 500 (operation panel 501) located at the first position overlaps a space through which the fixing apparatus 80 moves from the use position to the upper position. That is, the operation unit 500 (operation panel 501) at the first position restricts the movement of the fixing apparatus 80 from the use position to the upper position. However, when the operation unit 500 (operation panel 501) moves to the second position, the fixing apparatus 80 is permitted to move from the use position to the upper position.

The configurations of the above embodiments may be combined with one another. For example, the movement of the image scanner 200 and the movement of the operation unit 500 described in the first to fifth embodiments are not limited to being independent of each other, and the amount of movement can be minimized by combining the respective movement configurations and moving directions.

According to the present disclosure, conventional techniques can be further advanced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082771, filed May 16, 2025, which is hereby incorporated by reference herein in its entirety.

What is claimed is:

1. An image forming apparatus comprising:
an apparatus main body including an image forming portion configured to form an image on a recording material;
a fixing unit configured to be attachable to and detachable from the apparatus main body and configured to fix the image, formed on the recording material, to the recording material;
a support mechanism configured to support the fixing unit so that the fixing unit is movable between a use position for performing a fixing operation and an upper position above the use position; and
an upper device arranged above the fixing unit located at the use position in the apparatus main body, the upper device including a document table and a reading unit configured to read an image from a document placed on the document table,
wherein the fixing unit passes through a removal path when being removed from the apparatus main body from the use position via the upper position,
wherein the upper device includes a moving portion, the moving portion being configured to be movable between a first position overlapping the removal path and a second position separated from the removal path, and the moving portion includes the document table.

2. The image forming apparatus according to claim 1, wherein
in a horizontal direction, the apparatus main body has a first end and a second end opposite to the first end, and the fixing unit located at the use position is closer to the first end than to the second end, and
movement of the moving portion from the first position to the second position causes the document table to move in a direction from the first end toward the second end of the apparatus main body.

3. The image forming apparatus according to claim 1, wherein
movement of the moving portion from the first position to the second position causes the document table to move from a lower side to an upper side.

4. The image forming apparatus according to claim 1, wherein
in a horizontal direction, the apparatus main body has a first end and a second end opposite to the first end, and the fixing unit located at the use position is closer to the first end than to the second end,
the moving portion is rotatable relative to the apparatus main body about a rotation axis extending in a direction intersecting a vertical direction, and
movement of the moving portion from the first position to the second position causes an end portion of the document table on a side corresponding to the first end of the apparatus main body to move from a lower side to an upper side and in a direction from the first end toward the second end of the apparatus main body.

5. The image forming apparatus according to claim 1, wherein
in a state in which the upper device is located at the first position, a document reading operation by the reading unit is permitted.

6. An image forming apparatus comprising:
an apparatus main body including an image forming portion configured to form an image on a recording material;
a fixing unit configured to be attachable to and detachable from the apparatus main body and configured to fix the image, formed on the recording material, to the recording material;
a support mechanism configured to support the fixing unit so that the fixing unit is movable between a use position for performing a fixing operation and an upper position above the use position; and
an upper device arranged above the fixing unit located at the use position in the apparatus main body, the upper device including a document table and a reading unit configured to read an image from a document placed on the document table,
wherein the fixing unit passes through a removal path when being removed from the apparatus main body from the use position via the upper position, and
wherein the upper device includes a moving portion, the moving portion being configured to be movable between a first position overlapping the removal path and a second position separated from the removal path, and
a moving path of the moving portion between the first position and the second position includes a linear path.

7. The image forming apparatus according to claim 6, wherein
the upper device includes an operation portion of the reading unit, and
the moving portion includes the operation portion.

8. The image forming apparatus according to claim 7, wherein
in a horizontal direction, the apparatus main body has a first end and a second end opposite to the first end, and the fixing unit located at the use position is closer to the first end than to the second end,
the upper device includes a support member that supports the operation portion, the support member being capable of displacing a position of the operation portion relative to the apparatus main body,
the moving portion includes the support member, and
movement of the moving portion from the first position to the second position causes displacement of a position, at which the support member supports the operation portion, in a direction from the first end toward the second end of the apparatus main body.

9. The image forming apparatus according to claim 8, wherein
the operation portion is rotatably supported relative to the support member about a rotation axis in a direction intersecting an up-down direction, the operation portion is configured to be capable of assuming a tilted orientation in which a lower end of the operation portion protrudes further toward the first end of the apparatus main body than an upper end of the operation portion and an upright orientation in which positions of the lower and upper ends of the operation portion are substantially aligned in a horizontal direction, and
the operation portion is configured such that displacement of the position, at which the support member supports the operation portion, from a side corresponding to the first end of the apparatus main body to a side corresponding to the second end changes an orientation of the operation portion from the tilted orientation to the upright orientation.

10. The image forming apparatus according to claim 6, wherein
the linear path is a path along a horizontal direction.

11. The image forming apparatus according to claim 1, wherein
the image forming portion is configured to be movable to outside the apparatus main body,
the fixing unit located at the use position overlaps a moving path of the image forming portion moving from inside the apparatus main body to outside the apparatus main body, and
the fixing unit located at the upper position is separated from the moving path.

12. The image forming apparatus according to claim 11, wherein
the moving portion is configured such that movement of the fixing unit from the use position to the upper position causes the moving portion to move from the first position to the second position.

13. The image forming apparatus according to claim 11, wherein
the apparatus main body includes:
an opening portion through which the image forming portion passes; and
an opening and closing member movable to a closing position for closing the opening portion and an opening position for opening the opening portion, wherein
the moving portion is configured such that movement of the opening and closing member from the closing position to the opening position causes the moving portion to move from the first position to the second position.

14. The image forming apparatus according to claim 13, wherein
in a horizontal direction, the apparatus main body has a first end and a second end opposite to the first end, and the fixing unit located at the use position is closer to the first end than to the second end, and
the opening portion is provided on a side corresponding to the first end of the apparatus main body.

15. The image forming apparatus according to claim 1, wherein
in a horizontal direction, the apparatus main body has a first end and a second end opposite to the first end, and the fixing unit located at the use position is closer to the first end than to the second end,
the upper device is arranged above the apparatus main body, and
the apparatus main body includes a pillar portion that supports the upper device, and the pillar portion is closer to the second end than to the first end.

16. The image forming apparatus according to claim 15, wherein
the apparatus main body further includes a discharge tray from which a recording material, on which an image is fixed, is discharged, and
the reading unit is arranged above the discharge tray.

17. The image forming apparatus according to claim 16, wherein
the discharge tray is opened to at least a side corresponding to the second end of the apparatus main body.

18. The image forming apparatus according to claim 6, wherein
in a horizontal direction, the apparatus main body has a first end and a second end opposite to the first end, and the fixing unit located at the use position is closer to the first end than to the second end,
the upper device is arranged above the apparatus main body, and
the apparatus main body includes a pillar portion that supports the upper device, and the pillar portion is closer to the second end than to the first end.

19. The image forming apparatus according to claim 18, wherein
the apparatus main body further includes a discharge tray from which a recording material, on which an image is fixed, is discharged, and
the reading unit is arranged above the discharge tray.

20. The image forming apparatus according to claim 19, wherein
the discharge tray is opened to at least a side corresponding to the second end of the apparatus main body.
